(19) United States
(12) Patent Application Publication
(10) Pub. No.: US 2005/0172468 A1
(43) Pub. Date: Aug. 11, 2005

(54) Method for manufacturing a resilient body which can be applied in cushions, mattresses or the like

(76) Inventor: Willy Poppe, Sint-Niklaas (BE)

Correspondence Address: BACON & THOMAS, PLLC, 625 SLATERS LANE, FOURTH FLOOR, ALEXANDRIA, VA, 22314, US

(21) Appl. No.: 10/784,213

(22) Filed: Feb. 24, 2004

(30) Foreign Application Priority Data
Feb. 6, 2004 (BE) 2004/0070

(51) Int. Cl. B68G 7/00; B29C 53/00

(52) U.S. Cl. 29/91.1; 29/557

(57) ABSTRACT

Method for manufacturing a tubular, resilient body for pillows, mattresses or the like, which method mainly consists in providing slits (13) in a foam layer (2); in cutting a strip (8) out of this foam layer (2); in bending two opposite ends (11-12) of the strip (8) towards each other; and in fixing both these far ends (11-12) in order to form the aimed tubular, resilient body (1), characterised in that the foam layer (2) is made of what is called a viscoelastic foam (3), and in that at least a part of the cells present in the foam (3) are broken open.

### BACKGROUND OF THE INVENTION

1. Field of the Invention

The present invention concerns a method for manufacturing a resilient body, in particular a tubular, resilient body with radially directed cavities which can be applied in the core of pillows, mattresses, armchair cushions to sit on and the like.

2. Discussion of the Related Art

Such resilient bodies are known for example from BE 1,010,041 and they are made of a foam layer of for example latex or polyurethane foam, according to a method which consists of providing slits in the foam layer and cutting it up in strips, and by subsequently gluing together both ends of a thus obtained strip in order to form a hollow body with radially directed cavities.

In order to make such resilient bodies supple, strips made of polyurethane foam with a relatively low specific gravity are taken as a basis in the above-mentioned method, as the softness is inversely proportional to the specific gravity of the foam with such foams.

However, a disadvantage of such supple, resilient bodies is that, due to the low specific gravity, the resilience of the foam is lost relatively quickly, as a result of which the resilient bodies lose their functionality after a while when being applied in pillows or the like.

### SUMMARY OF THE INVENTION

The present invention aims to remedy the above-mentioned and other disadvantages.

To this end, the invention concerns a method for manufacturing a tubular, resilient body for pillows, mattresses or the like, which method mainly consists in providing slits in a foam layer; in cutting a strip out of this foam layer; in bending two opposite ends of the strip towards each other; and in fixing both these far ends in order to form the aimed tubular, resilient body, whereby the foam layer is made of what is called a viscoelastic foam, and whereby at least a part of the cells present in the foam are broken open.

An advantage of the method according to the invention is that a resilient body obtained in this manner retains its resilience for a long time and moreover remains supple when a relatively large pressure is exerted upon it.

Another advantage of the method according to the invention is that a thus obtained resilient body reassumes its original shape relatively slowly after a pressure has been exerted upon it, so that, when it is applied for example in a pillow, it allows the user to raise his head for a moment and then lower it back in its original pose on the pillow, without the pillow having changed shape in the meantime, which may be considered as an improvement of the user's comfort.

Another advantage of the present method is that the closed cells created as a result of gas inclusions during the production of the foam are broken open, so that a more open foam structure is obtained, allowing for a better air circulation, and so that the foam will moreover spring in a softer manner.

The closed cells are preferably broken open in the foam by pressing the foam entirely or almost entirely together, whereby the gas pressure in the cells rises such that the cells burst so to say.

### BRIEF DESCRIPTION OF THE DRAWINGS

In order to better explain the characteristics of the invention, the following preferred embodiment of a method according to the invention for manufacturing a resilient body is described as an example only without being limitative in any way, with reference to the accompanying drawings, in which:

FIG. 1 represents a resilient body made by means of a method according to the invention;

FIG. 2 represents a section according to line II-II in FIG. 1;

FIG. 3 represents a foam strip applied in a method according to the invention to a smaller scale;

FIGS. 4 and 5 schematically represent a few steps of the method according to the invention;

FIG. 6 represents a possible application of the above-mentioned resilient body.

### DESCRIPTION OF THE PREFERRED EMBODIMENT

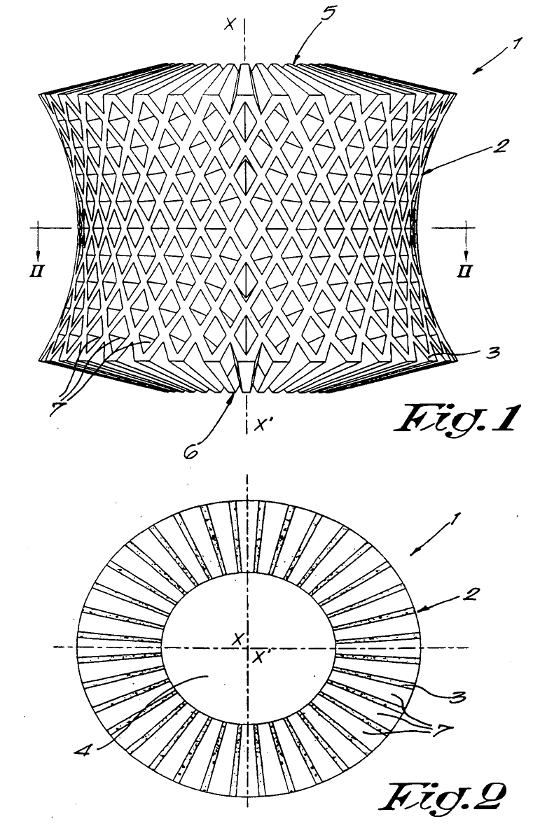

FIGS. 1 and 2 represent a resilient body 1 aimed according to the method of the invention.

This resilient body 1 is mainly made tubular with an imaginary X-X′ axis, and it is made of a layer 2 of a viscoelastic foam 3 according to the invention, limiting a central space 4, which space 4 extends as of one far end 5 of the body 1 to the other far end 6.

The outside of the one far end 5 towards the other far end 6 is preferably biconical, or almost biconical, by which is meant that the addendum line of the body 1 decreases as of both far ends 5-6 up to halfway the middle of both far ends 5-6.

The surfaces on both far ends 5-6 of the body 1 are preferably somewhat conical on the outside, which promotes the resilience of the body 1.

As represented in FIG. 2, the body 1, seen as a cross section, is preferably circular, whereby the central space 4 is in this case made cylindrical.

In the body 1 are provided cavities 7 which are radially directed from the outside to the inside.

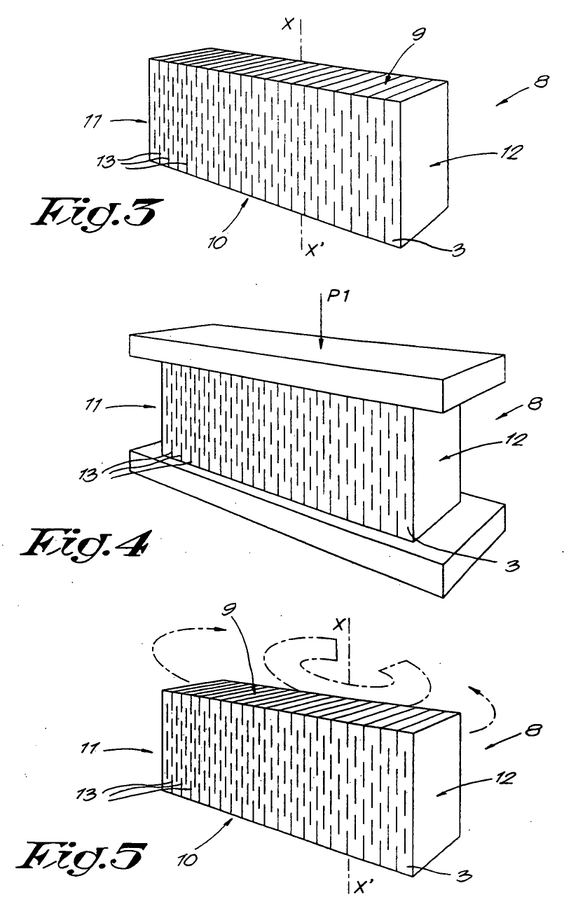

A method according to the invention for manufacturing the above-described resilient body 1 is relatively simple and is illustrated by means of FIGS. 3 to 5.

The applied foam is preferably made of a viscoelastic material which has a characteristic that it becomes suppler at body temperature, whereas it is more elastic at ambient temperature and reassumes its original shape relatively faster.

In a first step, a rectangular strip 8 is cut out of a viscoelastic foam layer with an axis of symmetry X-X′ and with two pairs of parallel side walls 9-10, 11-12 respectively.

In the strip 8 are provided slits 13, preferably according to a direction which is parallel to the aforesaid axis of symmetry X-X′.

This strip 8 is then pressed together entirely or almost entirely, for example in a direction according to arrow P1 in FIG. 4, whereby at least a part of the cells in the viscoelastic foam 3 are broken open, such that the foam 3 obtains a more open structure and allows for a good air circulation.

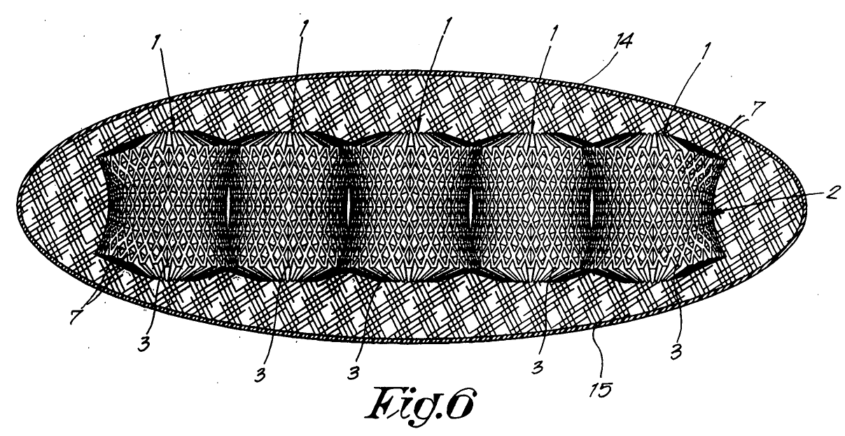

After having pressed together the foam 3 and after it has reassumed its original shape, the strip 8 is bent, as is schematically represented by means of a chain line in FIG. 5, whereby the side walls 11-12 of the strip 8 are fixed together in order to form the aimed tubular, resilient body 1.

As a result of the aforesaid bending the strip 8 is stretched, so that the slits 13 are drawn open up to the aforesaid cavities 7 extending radially through the body 1, and due to the created tension, the outside of the tubular body 1 is transformed into a biconical or almost biconical shape between the far ends 5-6 of the body 1.

It should be noted that the shape of the resilient body 1 can be obtained by means of different known methods, which methods are all included within the scope of the present invention.

Naturally, different steps of the method according to the invention can be carried out in a different order without this having any influence on the result. Thus, the compression of the foam 3 can take place in any stage of the production, although it is preferably done before bending the strip 8 into a tubular body 1.

Also providing slits 13 in the foam layer 2 can take place at different stages of the method, for example before or after cutting the foam layer 2 into one or several strips 8, and it is not excluded that, in order to form the resilient body 1, a strip 8 is taken as a basis which has been sized beforehand and which has been provided with the appropriate slits 13.

FIG. 6 represents a possible application of a resilient body 1 made by means of a method according to the invention, whereby several of such resilient bodies 1 are provided in a casing 14 made of a soft polymer material, such as for example polyester. As is known, the casing 14 itself is covered by a ticking 15.

The present invention is by no means limited to the above-described embodiments given as an example and represented in the accompanying drawings; on the contrary, such a method for manufacturing a resilient body can be made in all sorts of variants while still remaining within the scope of the invention.

1. A method for manufacturing a tubular, resilient body for pillows, mattresses or the like, which method mainly consists in providing slits in a foam layer; in cutting a strip out of this foam layer; in bending two opposite ends of the strip towards each other; and in fixing both these far ends in order to form the aimed tubular, resilient body, wherein the foam layer is made of what is called a viscoelastic foam, and in that at least a part of the cells present in the foam are broken open.

2. The method according to claim 1, wherein the cells are broken open by pressing the foam together.

3. The method according to claim 1, wherein the slits are provided in the axial X-X′ direction of the tubular, resilient body.

4. The method according to claim 1, wherein the far ends of the strip are bent such that a tubular body is formed with a biconical or almost biconical shape on the outside.

5. The method according to claim 1, wherein the strip is stretched at least in its longitudinal direction when being bent, whereby the slits are drawn open in order to form cavities.
